(19) United States
(12) Patent Application Publication
(10) Pub. No.: US 2025/0118470 A1
(43) Pub. Date: Apr. 10, 2025

(54) SOFT MAGNETIC MATERIAL AND METHOD FOR PRODUCING THE SAME

(71) Applicant: TOYOTA JIDOSHA KABUSHIKI KAISHA, Toyota-shi (JP)

(72) Inventors: Masaaki ITO, Anjo-shi (JP); Motoki HIRAOKA, Toyota-shi (JP); Kensuke KOMORI, Toyota-shi (JP); Yusuke ONITSUKA, Toyota-shi (JP); Takuya NOMURA, Kasugai-shi (JP)

(73) Assignee: TOYOTA JIDOSHA KABUSHIKI KAISHA, Toyota-shi (JP)

(21) Appl. No.: 18/891,038

(22) Filed: Sep. 20, 2024

(30) Foreign Application Priority Data
Oct. 10, 2023 (JP) 2023-175416

(51) Int. Cl. H01F 1/153; C22C 38/00; C22C 38/02; H01F 1/147

(52) U.S. Cl. CPC H01F 1/15308; C22C 38/001; C22C 38/002; C22C 38/02; H01F 1/14733; H01F 1/14766; H01F 1/15333; H01F 1/15341

(57) ABSTRACT

A soft magnetic material and a method for producing the same. The soft magnetic material is: Fe_{100-x-y-z-w}BₓNi_{y}Si_{z}M_{w} (In the formula, M is one or more inevitable elements selected from Nb, Mo, Ta, W, Co, and Sn, and x, y, z, and w are in atomic percent satisfying 12≤x≤17, 1≤y≤3, 0<z≤1, 0<w≤0.1). Soft magnetic material includes α-Fe phase which contains crystals whose average particle size is 30 nm or less. The average particle size of crystals is average value of projected area circular equivalent diameters of crystals in a transmission electron microscope image of soft magnetic material thinned by focused ion beam. The ratio of peak area of crystalline plane to overall peak area as measured by XRD of α-Fe phase on surface of soft magnetic material is equal to or greater than 0.10.

### CROSS REFERENCE TO RELATED APPLICATIONS

The present application claims priority from Japanese patent application JP 2023-175416 filed on Oct. 10, 2023, the entire content of which is hereby incorporated by reference into this application.

### BACKGROUND

### Technical Field

The present disclosure relates to a soft magnetic material and a method for producing the same.

### Background Art

To achieve high performance in motors and reactors and other components, the soft magnetic material used in the core portions of such components must have both a high saturation magnetic flux density (high torque) and a low coercive force (low loss).

Soft magnetic materials with high saturation magnetic flux density include electromagnetic steel sheets, Fe-based nanocrystalline soft magnetic materials, and the like. Fe-based nanocrystalline soft magnetic materials are soft magnetic materials in which the main component is Fe, and nanocrystals are dispersed within the material.

For example, JP H06-41698 A describes a Fe-based soft magnetic alloy in which the general formula Fe_{100-a-b-c-d-e}NiₐM_{b}B_{c}M′_{d}M″ₑ (In the formula, M represents Si, Ge, Ga, M′ represents Nb, Mo, W, Ta, Zr, Hf, Ti, M″ represents one or more elements selected from V, Cr, Mn, Al, and a, b, c, d, and e are in atomic percent and satisfy 0.5≤a≤5, 0≤b≤10, 9≤c≤16, 1≤d≤6, 0≤e≤2, and 16≤a+b+c+d+e≤25, respectively.

JP 2018-22797 A describes a method for producing a soft magnetic material that includes preparing an alloy having a composition represented by the following compositional formula 1 or compositional formula 2 and having an amorphous phase, and heating the alloy at a temperature increase rate of 10° C./sec or more and holding it for 0 to 80 seconds at a crystallization starting temperature or higher and below an Fe—B compound formation start temperature. The compositional formula 1 is Fe_{100-x-y}BₓM_{y} in which M is at least one element selected from Nb, Mo, Ta, W, Ni, Co, and Sn, and x and y are in atomic percent and satisfy 10≤x≤ 16 and 0≤y≤8, and the compositional formula 2 is Fe_{100-a-b-c}BₐCu_{b}M′_{c}, M′ is at least one element selected from Nb, Mo, Ta, W, Ni, and Co, and a, b, and c are in atomic percent and satisfy 10≤a≤16, 0 <b≤2, and 0≤c≤8.

### SUMMARY

To improve the performance of magnetic components such as motors and reactors, it is important to achieve both the high saturation magnetic flux density and the low coercive force of the soft magnetic material in the core portion, as described above.

The Fe-based nanocrystalline soft magnetic materials have high saturation magnetic flux density because their main components are Fe. The Fe-based nanocrystalline soft magnetic materials are obtained by heat treatment (also called “annealing”) of an alloy with an amorphous phase. When a Fe content in the alloy with an amorphous phase is high, the crystalline phase (α-Fe) is easily formed from the amorphous phase during the heat treatment, and the crystalline phase is easily coarsened by grain growth. Therefore, an element that inhibit the grain growth are added to the material. However, the Fe content in the material decreases by the added amount of the element, resulting in a decrease in the saturation magnetic flux density of the material. From the above, when the main component of the soft magnetic material is Fe, it is difficult to hold the high saturation magnetic flux density while suppressing the coarsening of the crystalline phase during the heat treatment to hold the low coercive force.

The present disclosure provides a soft magnetic material having both a high saturation magnetic flux density and a low coercive force, and a method for producing the same.

As a result of various investigations into means to solve the above-described problems, the present inventors have completed the present disclosure by finding that by rapid heat treatment of an alloy having an amorphous phase whose main component is Fe and containing an appropriate amount of Si, an Fe-based nanocrystalline soft magnetic material with high saturation magnetic flux density can be obtained while holding a low coercive force.

In other words, the gist of the present disclosure is as follows.
(1) A soft magnetic material represented by a following compositional formula: Fe_{100-x-y-z-w}BₓNi_{y}Si_{z}M_{w} (In the formula, M is one or more inevitable elements selected from Nb, Mo, Ta, W, Co, and Sn, and x, y, z, and w are in atomic percent satisfying 12≤x≤17, 1≤y≤3, 0<z≤1, 0<w≤0.1). The soft magnetic material includes an α-Fe phase. The a-Fe phase contains crystals whose average particle size is 30 nm or less. The average particle size of the crystals is an average value of projected area circular equivalent diameters of the crystals in a transmission electron microscope (TEM) image of the soft magnetic material thinned by a focused ion beam (FIB). A ratio of a peak area of the crystalline (211) plane (crystalline (211) plane peak area) to an overall peak area (total XRD peak area) as measured by XRD of the α-Fe phase on the surface of the soft magnetic material (crystalline (211) plane peak area/total XRD peak area) is equal to or greater than 0.10.
(2) In the soft magnetic material according to (1), z satisfies 0.2≤z≤0.9.
(3) A method for producing a soft magnetic material comprising preparing an alloy having a composition represented by a following compositional formula: Fe_{100-x-y-z-w}BₓNi_{y}Si_{z}M_{w} (In the formula, M is one or more inevitable elements selected from Nb, Mo, Ta, W, Co, and Sn, and x, y, z, and w are in atomic percent satisfying 12≤x≤17, 1≤y≤3, 0<z≤1, 0<w≤0.1) and an amorphous phase; and performing rapid heat treatment on the alloy such that an attained temperature of the alloy is in a temperature range from a crystal formation start temperature of an α-Fe phase to below a Fe—B compound formation start temperature.
(4) In the method for producing a soft magnetic material according to (3), in the rapid heat treatment, the attained temperature of the alloy is from 485° C. to 500° C.
(5) In the method for producing a soft magnetic material according to (3) or (4), in the rapid heat treatment, a temperature increase rate of the alloy is 100° C./sec to 415° C./sec.
(6) In the method for producing a soft magnetic material according to any one of (3) to (5), in the rapid heat treatment, a holding time of the alloy is from 0 to 80 seconds.
(7) In the method for producing a soft magnetic material according to any one of (3) to (6), the rapid heat treatment is performed by clamping the alloy between heated blocks.

The present disclosure provides a soft magnetic material having both high saturation magnetic flux density and low coercive force, and a method for producing the material.

### BRIEF DESCRIPTION OF THE DRAWINGS

FIG. 1A is a graph illustrating a relationship between Si content and crystalline (211) plane peak area ratio for Example 5 and Comparative Examples 5 to 6;

FIG. 1B is a graph illustrating a relationship between Si content and saturation magnetic flux density for Example 5 and Comparative Examples 5 to 6;

FIG. 2 is a graph illustrating a relationship between heat treatment temperatures and saturation magnetic flux densities for Examples 1 to 7 and Comparative Examples 1 to 4; and

FIG. 3 is a graph illustrating a relationship between crystalline (211) plane peak area ratios and saturation magnetic flux densities for Examples 1 to 7 and Comparative Examples 1 to 4.

### DETAILED DESCRIPTION

The following is a detailed description of preferred embodiments of the present disclosure. In the present specification, the features of the present invention will be described with reference to the drawings as appropriate. The soft magnetic material and the method for producing the same are not limited to the following embodiments, but can be implemented in various forms with modifications, improvements, and the like that can be made by those skilled in the art, to the extent not departing from the gist of the present disclosure.

In the specification and others, the range expressed by “numerical value to numerical value” means the range including the numerical values.

### (Soft Magnetic Material)

The soft magnetic material of the present disclosure is represented by the following compositional formula: Fe_{100-x-y-z-w}BₓNi_{y}Si_{z}M_{w} (In the formula, M is one or more inevitable elements selected from Nb, Mo, Ta, W, Co, and Sn, and x, y, z, and w are in atomic percent satisfying 12≤x≤17, 1≤y≤3, 0 <z≤1, 0<w≤0.1) and is an Fe-based nanocrystalline soft magnetic material.

The composition of the amorphous alloy does not usually change during the production process of the soft magnetic material of the present disclosure. Therefore, the composition of the soft magnetic material of the present disclosure is the same as the composition of the amorphous alloy used in the production.

In the soft magnetic material of the present disclosure, the main component is Fe, and the Fe content is 50 atomic percent or more of the total composition. Therefore, 100-x-y-z-w, which indicates the Fe content, is 50 or more in atomic percent, and in terms of having a high saturation magnetic flux density, 80 or more in one embodiment, 85 or more in one embodiment.

The content of B (boron) is indicated by x, which is 12 to 17 in atomic percent and 12 to 14 in one embodiment.

When the soft magnetic material of the present disclosure contains B in the above-described range, along with securing the Fe content, its presence between the α-Fe crystals suppresses the crystal grain growth of α-Fe and holds the coercive force of the soft magnetic material low.

The content of Ni is indicated by y, which is 1 to 3 in atomic percent and 1.5 to 2.5 in one embodiment.

Ni contained in the soft magnetic material of the present disclosure in the above-described range allows a magnitude of an induced magnetic anisotropy to be controlled.

The content of Si is indicated by z, which is in a range of more than 0 and 1 or less in atomic percent, 0.2 to 0.9 in one embodiment, and 0.5 to 0.9 in one embodiment.

The soft magnetic material of the present disclosure containing Si in the above-described range allows increasing a peak area ratio of (211) plane measured by X-Ray Diffraction (XRD) of the α-Fe phase on the surface of the soft magnetic material.

The contents of inevitable elements “M” is indicated by w, which is in the range of more than 0 and 0.1 or less in atomic percent, and more than 0 and 0.05 or less in one embodiment. The inevitable elements refer to impurities, such as impurities contained in raw materials, the inclusion of which cannot be avoided, or whose avoidance would result in a significant increase in the production cost.

The fact that the soft magnetic material of the present disclosure contains inevitable elements in the above-described range allows suppressing the decrease in the saturation magnetic flux density due to the increase in the inevitable elements.

The soft magnetic material of the present disclosure may contain one or more elements selected from the group consisting of, for example, Zr, Hf, Cu, Ag, Au, Zn, As, Sb, Bi, Y, rare earth elements, and the like, to the extent that the saturation magnetic flux density is not significantly reduced, in order to improve corrosion resistance, suppress the crystal grain growth, and increase a nucleation frequency.

In the soft magnetic material of the present disclosure, the ratio of the peak area of the crystalline (211) plane (crystalline (211) plane peak area) to the total peak area (total XRD peak area) measured by XRD of the α-Fe phase on the surface of the soft magnetic material (crystalline (211) plane peak area/total XRD peak area, which is hereafter also referred to as “crystalline (211) plane peak area ratio”) is 0.10 or more, 0.100 or more in one embodiment, 0.102 or more in one embodiment, and 0.105 or more in one embodiment. The crystalline (211) plane peak area ratio is not limited, but is usually 0.13 or less, and 0.12 or less in one embodiment.

Here, the peaks measured by XRD of the α-Fe phase on the surface of the soft magnetic material include peaks in (110) plane, (200) plane, (211) plane, (220) plane, and (310) plane as known in the art. Furthermore, (110) plane and (211) plane each have crystalline peaks and amorphous peaks (halo peaks). Therefore, the crystalline (211) plane peak area ratio in the present disclosure means a ratio of the peak area of the crystalline (211) plane to the total area of all the peaks observed by XRD, namely the total area of the peaks of crystalline (110) plane, amorphous (110) plane, (200) plane, crystalline (211) plane, amorphous (211) plane, (220) plane, and (310) plane.

The crystalline (211) plane peak area ratio can be calculated as follows.
(1) X-ray diffraction pattern of the soft magnetic material is measured by XRD.
(2) Normalize the obtained X-ray diffraction pattern by the peak of the (110) plane, which is the maximum intensity.
(3) For each peak, the background (BG) is linearly approximated using average values of 10 points at each end of 20 ranges including: 30° to 60° for the (110) plane, 60° to 70° for the (200) plane, 70° to 92° for the (211) plane, 94° to 102° for the (220) plane, and 112° to 120° for the (310) plane.
(4) For each peak with the BG subtracted, a peak fitting of the crystalline peak and the amorphous peak is performed using a split Pearson VII function, and the peak areas of Kα1 and Kα2 for each peak are calculated. In the soft magnetic material of the present disclosure, amorphous-derived halo peaks are confirmed in the (110) plane and the (211) plane. Therefore, the crystalline Kα1 and Kα2 and the amorphous Kα1 and Kα2 are observed in each of the (110) plane and the (211) plane.
(5) Calculate the crystalline (211) plane peak area ratio by dividing the peak area of Kα1 of the crystalline (211) plane by the sum of the peak areas of Kα1 of the respective peaks.

The crystalline (211) plane peak area ratio of the soft magnetic material of the present disclosure in the above-described range means that there are crystalline particles with anisotropically grown (aligned crystallographic orientation) in the (211) plane, which is a specific crystalline plane of the α-Fe phase in the soft magnetic material of the present disclosure. Such crystal particles result in the low coercive force (low loss) and the high saturation magnetic flux density (high torque) of the soft magnetic material.

The soft magnetic material of the present disclosure contains the crystals of the α-Fe phase 30% by volume or more to the total volume of the soft magnetic material, and 60% by volume or more in one embodiment.

The average particle size of the crystals of the α-Fe phase contained in the soft magnetic material of the present disclosure is 30 nm or less. The average particle size of the crystals of the α-Fe phase is not limited, but is usually 10 nm or more. Here, the average particle size of the crystals of the α-Fe phase is calculated by (1) thinning the soft magnetic material with a focused Ion beam (FIB); (2) observing the thinned soft magnetic material sample with a transmission electron microscope (TEM); (3) randomly selecting any number of the crystals (100 or more) from the α-Fe phase in the TEM image; (4) measuring the projected area equivalent circle diameter (Haywood diameter) of the selected crystals as the grain size; and (5) averaging the obtained grain sizes.

The high saturation magnetic flux density and the low coercive force of the soft magnetic material can be achieved by having the average particle size of the crystals of the a-Fe phase in the soft magnetic material of the present disclosure in the above-described range.

When the soft magnetic material of the present disclosure is in a ribbon form, the average thickness of the soft magnetic material of the present disclosure is not limited, but is usually 10 μm to 25 μm, and 15 μm to 30 μm in one embodiment.

By setting the thickness of the soft magnetic material of the present disclosure to the above-described range, the loss is allowed to be reduced.

The saturation magnetic flux density of the soft magnetic material of the present disclosure is usually 1.850 T or higher, 1.855 T or higher in one embodiment, for example, 1.850 T to 1.900 T, and 1.855 T to 1.900 T in one embodiment.

The coercive force of the soft magnetic material of the present disclosure is usually 20 A/m or less, 12 A/m or less in one embodiment, for example, 5 A/m to 20 A/m, and 7.0 A/m to 12 A/m in one embodiment.

The soft magnetic material of the present disclosure has both the high saturation magnetic flux density and the low coercive force, and can be used as the core of electronic components such as motors and reactors.

### (Method for Producing Soft Magnetic Material)

The soft magnetic material of the present disclosure can be produced by methods known in the art, for example, by the method described in JP No. 2019-206746 A, except that the alloy used as the raw material contains an appropriate amount of Si and that the alloy is subjected to a rapid heat treatment.

Example of a method for producing the soft magnetic material of the present disclosure is described below.

### (Preparation Step for Amorphous Alloys)

First, an alloy with an amorphous phase is prepared. The alloy with an amorphous phase is the raw material for the soft magnetic material of the present disclosure, which is usually the same as the composition of the soft magnetic material of the present disclosure, and its main component is Fe, as described above.

In the present disclosure, “the main component is Fe” means that the Fe content in the material is 50 atomic percent or more. “Alloy with an amorphous phase” means that the amorphous phase is present in the alloy by 50% by volume or more, which may be simply referred to as an “amorphous alloy”. The “alloy” may be in the form of ribbon, flake, granules, bulk, and the like.

The content of the amorphous phase in the amorphous alloy is 60% by volume or more in one embodiment and 85% by volume or more in one embodiment, from the viewpoint of obtaining a larger number of fine crystalline phases by the rapid heat treatment.

The amorphous alloys are obtained by quenching molten metal whose main component is Fe. B promotes the formation of the amorphous phase when the molten metal is quenched. When the content of B in the amorphous alloy obtained by quenching the molten metal (residual amount of B) is 12 atomic percent or more of the total composition, the main phase of the amorphous alloy can be the amorphous phase. On the other hand, the B content of the amorphous alloy is made to be 17 atomic percent or less of the total composition, which ensures the amount of Fe required for the high saturation magnetic flux density while avoiding the formation of Fe—B compounds during the crystallization of the amorphous phase.

The amorphous alloy contains Ni. The inclusion of Ni in the amorphous alloy allows the magnitude of the induced magnetic anisotropy to be controlled. From the viewpoint of clearly demonstrating the effect, the content of Ni is 1 atomic percent or more of the total composition. On the other hand, when the Ni content is 3 atomic percent or less of the total composition, Fe and B, which are other essential elements of the amorphous alloy, are not excessively low. As a result, the soft magnetic material obtained by the rapid heat treatment of the amorphous alloy can have both the high saturation magnetic flux density and the low coercive force.

In the amorphous alloy, some of the B is replaced by Si.

Conventionally, it has been known that Si is an element responsible for the amorphous formation and that the addition of Si can increase the temperature at which Fe—B compounds with large magnetocrystalline anisotropy are formed, thereby increasing the heat treatment temperature. In the present disclosure, it was found that by setting Si in an appropriate amount, namely, in the range from above 0 atomic percent to 1 atomic percent or less, 0.2 atomic percent to 0.9 atomic percent in one embodiment, and 0.5 atomic percent to 0.9 atomic percent in one embodiment of the total composition, the anisotropic growth of the crystals of the α-Fe phase by the heat treatment, that is, the growth of the (211) plane of the crystals of the α-Fe phase is promoted and the high saturation magnetic flux density can be achieved, unlike the previous teachings.

In addition, Si has the effect of reducing a viscosity of molten metal, making it easier to discharge the molten metal, and suppressing nozzle blockage.

In the amorphous alloy, one or more inevitable elements selected from the group consisting of Nb, Mo, Ta, W, Co, and Sn are included in the compositional formula.

The amorphous alloy may also contain one or more elements selected from the group consisting of, for example, Zr, Hf, Cu, Ag, Au, Zn, As, Sb, Bi, Y, and rare earth elements, to the extent that the saturation magnetic flux density is not significantly reduced, in order to improve the corrosion resistance, suppress the crystal grain growth, and increase the nucleation frequency.

Next, the method for producing the amorphous alloy will be described. There is no restriction on the method for producing the amorphous alloy as long as the amorphous alloy having the composition represented by the compositional formula described above can be obtained. As described above, the alloy may be in the form of ribbon, flake, granules, bulk, and the like. In order to obtain the desired form, the method for producing amorphous alloys can be selected as appropriate.

The method for producing the amorphous alloy includes, for example, preparing in advance an ingot blended such that the amorphous alloy has the composition represented by the compositional formula described above, and quenching the molten metal obtained by melting the ingot to obtain the amorphous alloy. When there are elements that are depleted during the melting of the ingot, an ingot with a composition that accounts for such depletion is prepared. When the ingot is melted after being crushed, homogenization heat treatment may be performed on the ingot prior to crushing.

The usual method of quenching the molten metal may be used, such as a single roll method using a cooling roll made of copper, copper alloys, or the like. The peripheral speed of the cooling roll in the single roll method may be the standard peripheral speed for producing the amorphous alloy whose main component is Fe. For example, the peripheral speed of the cooling roll may be usually 15 m/sec to 55 m/sec.

The temperature of the molten metal when discharging the molten metal into the single roll is usually 50° C. to 300° C. higher than the melting point of the ingot. There are no particular restrictions on the atmosphere in which the molten metal is discharged, but an atmosphere such as inert gas may be employed from the viewpoint of reducing contamination of oxides and other substances in the amorphous alloy.

(Rapid heat treatment Step for Amorphous Alloy)

The amorphous alloy is then subjected to the rapid heat treatment. The rapid heat treatment means that the amorphous alloy is heated rapidly to a predetermined temperature range, held for a short time, and then quenched. Specifically, the amorphous alloy is heated to a temperature of the crystal formation start temperature of the α-Fe phase or higher, as explained below, for example, usually 100° C. higher than the crystal formation start temperature of the α-Fe phase in one embodiment, 150° C. higher in one embodiment, and 200° C. higher in one embodiment at the temperature increase rate of usually 100° C./sec or higher to a temperature range below the Fe—B compound formation start temperature, and the temperature is held in the temperature range for 0 to 80 seconds, followed by cooling at usually a temperature drop rate of 100° C./sec or higher.

When the temperature increase rate is usually 100° C./sec or higher, the crystalline phase will not coarsen. From the viewpoint of avoiding coarsening of the crystalline phase, a faster temperature increase rate is desired, so the temperature increase rate is 150° C./sec or higher in one embodiment and 325° C./sec or higher in one embodiment. On the other hand, when the temperature increase rate is very fast, the heat source for heating becomes too large, which impairs economy. From the viewpoint of the heat source, the temperature increase rate is 415° C./sec or less in one embodiment. The temperature increase rate may be the average rate from the start of heating to the start of holding. The temperature increase rate may be the average rate from the start of heating to the start of cooling when the holding time is 0 seconds. Alternatively, the temperature increase rate may be the average rate over a certain temperature range, for example, between 100° C. and 500° C.

When the holding time is 0 seconds or longer, a fine crystalline phase is obtained from the amorphous phase. A holding time of 0 seconds means that the temperature is raised rapidly and then it is immediately cooled, or the holding is terminated. The holding time is 3 seconds or longer in one embodiment. On the other hand, when the holding time is 80 seconds or less, the coarsening of the crystalline phase can be avoided. From the viewpoint of avoiding the coarsening of the crystalline phase, the holding time is 60 seconds or less in one embodiment and 10 seconds or less in one embodiment.

When the heat treatment temperature (holding temperature) is usually the crystal formation start temperature of the α-Fe phase or higher, the amorphous phase can be turned into the crystalline phase and the nanocrystalline structure that is formed can be stabilized. On the other hand, when the holding temperature is the Fe—B compound formation start temperature or higher, the formation of the Fe—B compound causes a strong magnetocrystalline anisotropy, resulting in an increase in the coercive force. Therefore, the holding temperature is usually set below the Fe—B compound formation start temperature to allow the crystalline phase refinement without the formation of Fe—B compounds. Therefore, the heat treatment temperature is the crystal formation start temperature of the α-Fe phase or higher, or in the temperature range from above the crystal formation start temperature of the α-Fe phase to below the Fe—B compound formation start temperature in one embodiment, as explained below. In one embodiment, the heat treatment temperature is usually 485° C. to 500° C. The crystal formation start temperature of the α-Fe phase and the Fe—B compound formation start temperature may vary depending on the alloy system, but can be measured by DSC measurement, for example. The heat treatment temperature is the temperature that the amorphous alloy attains by heat treatment.

The heating method is not limited as long as the amorphous alloy can be heated at the temperature increase rate described so far.

When using an ordinary atmosphere furnace, the temperature increase rate and/or the holding temperature of the atmosphere in the furnace can be higher than the desired temperature increase rate and/or holding temperature for the amorphous alloy.

When an infrared furnace is used in place of the ordinary atmosphere furnace, the temporal discrepancy between the amount of heat input to the infrared heater and the amount of heat received by the amorphous alloy can be reduced. The infrared furnace is a furnace in which a light emitted by an infrared lamp is reflected by a concave surface to rapidly heat the heated material.

In addition, the temperature of the amorphous alloy may be rapidly raised and held by solid-to-solid heat transfer. For example, the amorphous alloy may be clamped between blocks that have already been heated to the desired holding temperature so as to rapidly raise and hold the temperature of the amorphous alloy.

The crystalline phase will not be further coarsened when the temperature drop rate of the soft magnetic material is usually 100° C./sec or higher, and 100° C./sec to 415° C./sec in one embodiment.

Although not bound by the theory, the following phenomena are thought to occur within the amorphous alloy when the amorphous alloy is subjected to the rapid heat treatment.

The temperature of the amorphous alloy is rapidly raised to a temperature range of the crystal formation start temperature of the α-Fe phase or higher and held in the temperature range for a short time. Therefore, the coarsening of the microstructure of the crystalline phase is avoided, and the resulting crystalline phase is considered to be finer.

Here, the size of the microstructure depends on the heterogeneous nucleation rate, and the heterogeneous nucleation rate is governed by atomic transport and the sizes of the critical nuclei.

In order to refine the microstructure, the heterogeneous nucleation rate should be increased, and in order to increase the heterogeneous nucleation rate, the atomic transport should be increased and the sizes of the critical nuclei should be decreased. To achieve these two conditions, it is effective to introduce a supercooled liquid region in the amorphous solid. Since the viscous flow is very large in the supercooled liquid region in the amorphous solid, the strain energy due to the nucleation in the supercooled liquid is much smaller than the strain energy due to the nucleation in the amorphous solid. Hence, in the supercooled liquid region, many embryos are nucleated.

In conventional heat treatments (annealing), however, the crystallization of amorphous solids begins at relatively low temperatures because of the slow temperature increase rate. Thus, at relatively low temperatures, the transition from solid to supercooled liquid is limited, and the heterogeneous nucleation is also very limited.

In contrast, the crystal formation start temperature of the α-Fe phase in the amorphous alloy can be increased when heated with the rapid temperature raise as in the present disclosure. The amorphous phase can then hold the amorphous solid state up to a high temperature where the transition of the amorphous solid to a supercooled liquid occurs actively. As the amorphous solid transitions to the supercooled liquid, the atomic transport is higher, the critical nucleus size is smaller, and the heterogeneous nucleation rate is higher. As a result, the nucleation frequency also increases.

Therefore, by rapidly raising the temperature of the amorphous alloy, the high atomic transport can be achieved and the active nucleation can occur within the region where the supercooled liquid is generated.

On the other hand, when the temperature of the amorphous alloy is raised rapidly, the grain growth rate also increases. In the present disclosure, since the holding time is short, the time for the grain growth to occur is reduced, thereby suppressing the grain growth.

In the crystallization process, when the thermal energy given to the amorphous alloy is insufficient (for example, low heat treatment temperature), the diffusion of atoms in the amorphous alloy will be insufficient, and the heat treatment is considered to be ended in an unstable state. Then, for example, when the obtained soft magnetic material is used in a high temperature environment, the thermal energy applied from the operating environment may cause migration of atoms in the material and change the short range structure of the material, resulting in a decrease in the magnetic properties of the material, for example, an increase in the coercive force of the material.

Therefore, the alloy with the amorphous phase is heated to the crystal formation start temperature of the α-Fe phase or higher, especially to a temperature usually 100° C. to 200° C. higher than the crystal formation start temperature of the α-Fe phase, for example, 100° C. to 150° C. higher in one embodiment. This allows sufficient diffusion of atoms in the amorphous alloy, for example, even when the resulting soft magnetic material is used in a high temperature environment, the migration of atoms (mainly the migration of B atoms) due to thermal energy applied from the operating environment is suppressed, and as a result, the magnetic properties of the material, especially the coercive force, are stabilized while remaining low.

On the other hand, when the temperature of the amorphous alloy attains the Fe—B compound formation start temperature, the Fe—B compound is formed. The Fe—B compound increases the coercive force due to its large magnetocrystalline anisotropy.

Therefore, the amorphous alloy can be heated below the Fe—B compound formation start temperature to suppress the formation of Fe—B compounds and hold good properties, especially the magnetic properties.

### EXAMPLES

The following is a description of some examples of the present disclosure, which is not intended to limit the present disclosure to those shown in the examples.

### (Preparation of Amorphous Alloys)

Raw materials were weighed to obtain the compositions shown in Table 1, and the ingots were made by arc melting. Pure Fe, Fe—B alloy, pure Ni, and the like were used as raw materials. In the step, the ingot was melted repeatedly (3 to 5 times) by inverting it such that it became homogeneous.

The finely cut ingot was charged into the nozzle of a liquid quenching device (single roll method) and melted by high frequency heating in an inert atmosphere to obtain molten metal. The molten metal was then discharged onto a copper roll with a peripheral speed of 30 m/s to 70 m/s and quenched to obtain a ribbon-shaped amorphous alloy of 5 mm width. The temperature at discharge was set at the melting point+50° C. to 200° C. The quenching conditions were adjusted by setting the gap at 0.4 mm and controlling the chamber internal pressure and the nozzle internal pressure such that the discharge pressure was 40 kPa to 80 kPa.

For the amorphous alloy, the amorphous nature was confirmed by XRD and the composition was confirmed by ICP before the heat treatment, which is described next.

### (Heat Treatment of Amorphous Alloys)

The amorphous alloys having the compositions listed in Table 1 were placed between a heating plate (made of stainless steel) and a calcium silicate plate, which were heated such that the temperature of the amorphous alloys attained the heat treatment temperatures listed in Table 1 by clamping them to have the heating plate-the amorphous alloy-the calcium silicate plate and then heating for 3 seconds, and then rapidly cooled by separating them from the heating plate. The amorphous phase in the amorphous alloy was crystallized by the heating, to make a soft magnetic material as a samples. The temperature increase rate was 100° C./sec or more, and the cooling rate was 100° C./sec.

### (Evaluation of Samples)

XRD (apparatus: Rigaku SmartLab II) analysis was performed on each heat-treated sample under the conditions described in Table 2, and the area ratio of each peak of the α-Fe phase was calculated. The area ratio of each peak was calculated according to the method described above. The coercive force and the saturation magnetic flux density were then measured for each heat-treated sample using a VSM (vibrating sample magnetometer)-P2H type-Helmholtz coil 2000e (manufactured by Toci Industry Co., Ltd.).

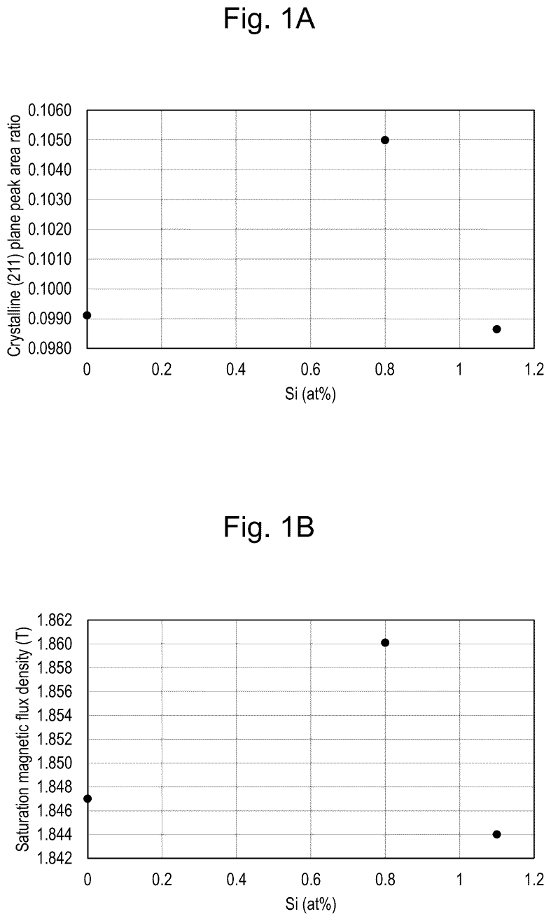

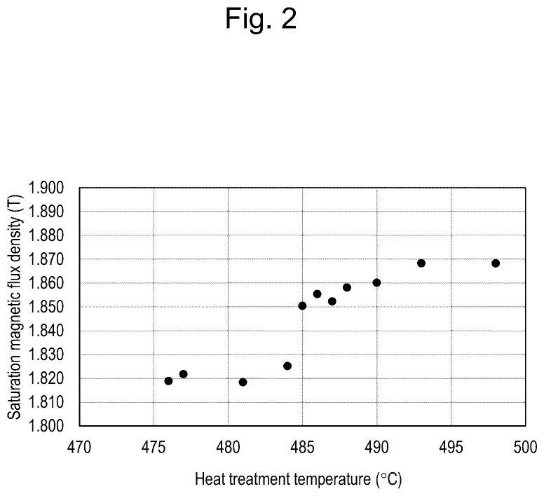

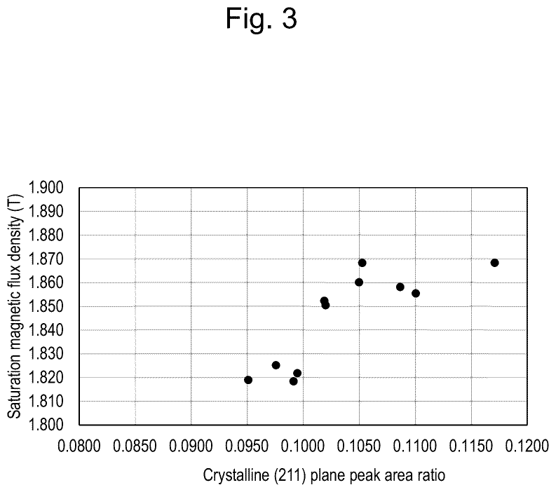

Table 1 and FIGS. 1A to 3 show the results. FIG. 1A illustrates a relationship between Si contents and crystalline (211) plane peak area ratios for samples whose heat treatment temperature is 490° C. (Example 5 and Comparative Examples 5 to 6). FIG. 1B illustrates a relationship between Si contents and saturation magnetic flux densities for samples whose heat treatment temperature is 490° C. (Example 5 and Comparative Examples 5 to 6). FIG. 2 illustrates a relationship between heat treatment temperature and saturation magnetic flux density for samples with Si content of 0.8 atomic percent (Examples 1 to 7 and Comparative Examples 1 to 4). FIG. 3 illustrates a relationship between crystalline (211) plane peak area ratio and saturation magnetic flux density for samples with Si content of 0.8 atomic percent.

TABLE 1

| | | Example 1 | Example 2 | Example 3 | Example 4 | Example 5 | Example 6 | Example 7 |
|---|---|---|---|---|---|---|---|---|
| Composition | Fe (at %) | 83.7 | | | | | | |
| | Ni (at %) | 2 | | | | | | |
| | B (at %) | 13.5 | | | | | | |
| | Si (at %) | 0.8 | | | | | | |
| Heat treatment | Heat treatment | 485 | 487 | 486 | 488 | 490 | 496 | 493 |
| condition | temperature (° C.) | | | | | | | |
| | Heat treatment | 3 | | | | | | |
| | time (sec) | | | | | | | |
| Magnetic | Saturation magnetic | 1.850 | 1.852 | 1.855 | 1.858 | 1.860 | 1.868 | 1.868 |
| property | flux density (T) | | | | | | | |
| | Coercive force (A/m) | 10.120 | 7.402 | 11.923 | 7.709 | 9.144 | 7.374 | 11.416 |
| XRD peak | (110) | 0.3258 | 0.3349 | 0.3283 | 0.3573 | 0.3244 | 0.3430 | 0.3347 |
| area ratio | (110) amo | 0.3347 | 0.3265 | 0.3323 | 0.3087 | 0.3320 | 0.3301 | 0.3101 |
| | (200) | 0.0518 | 0.0568 | 0.0595 | 0.0581 | 0.0576 | 0.0564 | 0.0603 |
| | (211) | 0.1020 | 0.1019 | 0.1101 | 0.1087 | 0.1050 | 0.1053 | 0.1171 |
| | (211) amo | 0.0901 | 0.0914 | 0.0740 | 0.0582 | 0.0816 | 0.0607 | 0.0650 |
| | (220) | 0.0342 | 0.0340 | 0.0382 | 0.0377 | 0.0373 | 0.0379 | 0.0429 |
| | (310) | 0.0614 | 0.0545 | 0.0576 | 0.0713 | 0.0622 | 0.0665 | 0.0700 |

| | | | | | | | |
|---|---|---|---|---|---|---|---|
| Total XRD peak area ratio | 1 | 1 | 1 | 1 | 1 | 1 | 1 |

| | | Comparative | Comparative | Comparative | Comparative | Reference | Comparative | Comparative |
|---|---|---|---|---|---|---|---|---|
| | | Example 1 | Example 2 | Example 3 | Example 4 | Example 1 | Example 5 | Example 6 |
| Composition | Fe (at %) | 83.7 | | | | | 83.4 | 84.5 |
| | Ni (at %) | 2 | | | | | | |
| | B (at %) | 13.5 | | | | | | |
| | Si (at %) | 0.8 | | | | | 1.1 | 0 |
| Heat treatment | Heat treatment | 481 | 476 | 477 | 484 | None | 490 | 490 |
| condition | temperature (° C.) | | | | | | | |
| | Heat treatment | 3 | | | | | | |
| | time (sec) | | | | | | | |
| Magnetic | Saturation magnetic | 1.818 | 1.819 | 1.822 | 1.825 | 1.662 | 1.844 | 1.847 |
| property | flux density (T) | | | | | | | |
| | Coercive force (A/m) | 11.733 | 9.309 | 11.236 | 10.790 | 7.214 | 10.136 | 9.980 |
| XRD peak | (110) | 0.3261 | 0.3245 | 0.3107 | 0.3252 | 0.0171 | 0.3322 | 0.3165 |
| area ratio | (110) amo | 0.3454 | 0.3519 | 0.3782 | 0.3556 | 0.8015 | 0.3156 | 0.3458 |
| | (200) | 0.0561 | 0.0521 | 0.0567 | 0.0539 | 0.0058 | 0.0557 | 0.0592 |
| | (211) | 0.0991 | 0.0951 | 0.0995 | 0.0976 | 0.0058 | 0.0986 | 0.0991 |
| | (211) amo | 0.0819 | 0.0833 | 0.0612 | 0.0718 | 0.1544 | 0.0895 | 0.0904 |
| | (220) | 0.0338 | 0.0344 | 0.0368 | 0.0375 | 0.0095 | 0.0371 | 0.0316 |
| | (310) | 0.0575 | 0.0586 | 0.0569 | 0.0584 | 0.0058 | 0.0713 | 0.0575 |

| | | | | | | | |
|---|---|---|---|---|---|---|---|
| Total XRD peak area ratio | 1 | 1 | 1 | 1 | 1 | 1 | 1 |

TABLE 2
XRD measurement condition

| Analysis method | | Wide angle method |
|---|---|---|
| Analyzer | | Rigaku Smart Lab II |
| Analysis | Measurement angle | 5* to 120* |
| condition | Bulb | Cu |
| | Optical system | Kα |
| | kV | 45 |
| | mA | 200 |
| | Measurement method | Continuous method |
| | Step | 0.02° |
| | Rate | 5°/min |
| | IS | 2/3 |
| | RS | 20 mm |
| | Detection mode | One dimensional |

In Table 1, “amo” indicates amorphous peaks. From Table 1 and FIGS. 1A and 1B, it was found that the saturation magnetization can be improved by increasing the crystalline (211) plane peak area ratio with the appropriate content of Si. From Table 1 and FIG. 2, it was found that the crystalline (211) plane peak area ratio can be controlled by the rapid heat treatment, especially the heat treatment temperature, during the production of the soft magnetic material of the present disclosure. Furthermore, from Table 1 and FIG. 3, it was found that the saturation magnetization can be improved by increasing the crystalline (211) plane peak area ratio in the soft magnetic material of the present disclosure.

All publications, patents and patent applications cited in the present description are herein incorporated by reference as they are.

What is claimed is:

1. A soft magnetic material represented by a following compositional formula:
Fe_{100-x-y-z-w}BₓNi_{y}Si_{z}M_{w} (In the formula, M is one or more inevitable elements selected from Nb, Mo, Ta, W, Co, and Sn, and x, y, z, and w are in atomic percent satisfying 12≤x≤17, 1≤y≤3, 0<z≤1, 0<w≤0.1), and
wherein the soft magnetic material includes an α-Fe phase,
wherein the α-Fe phase contains crystals whose average particle size is 30 nm or less,
wherein the average particle size of the crystals is an average value of projected area circular equivalent diameters of the crystals in a transmission electron microscope (TEM) image of the soft magnetic material thinned by a focused ion beam (FIB),
wherein a ratio of a peak area of the crystalline (211) plane to an overall peak area as measured by XRD of the α-Fe phase on the surface of the soft magnetic material is equal to or greater than 0.10.

2. The soft magnetic material according to claim 1,
wherein z satisfies 0.2≤z≤0.9.

3. A method for producing a soft magnetic material, comprising
preparing an alloy having a composition represented by a following compositional formula: Fe_{100-x-y-z-w}BₓNi_{y}Si_{z}M_{w} (In the formula, M is one or more inevitable elements selected from Nb, Mo, Ta, W, Co, and Sn, and x, y, z, and w are in atomic percent satisfying 12≤x≤17, 1≤y≤3, 0<z≤1, 0<w≤0.1), and an amorphous phase; and
performing rapid heat treatment on the alloy such that an attained temperature of the alloy is in a temperature range from a crystal formation start temperature of an α-Fe phase to below a Fe—B compound formation start temperature.

4. The method for producing a soft magnetic material according to claim 3,
wherein in the rapid heat treatment, the attained temperature of the alloy is from 485° C. to 500° C.

5. The method for producing a soft magnetic material according to claim 4,
wherein in the rapid heat treatment, a temperature increase rate of the alloy is 100° C./sec to 415° C./sec.

6. The method for producing a soft magnetic material according to claim 5,
wherein in the rapid heat treatment, a holding time of the alloy is from 0 to 80 seconds.

7. The method for producing a soft magnetic material according to claim 3,
wherein the rapid heat treatment is performed by clamping the alloy between heated blocks.
